(19) United States
(12) Patent Application Publication
(10) Pub. No.: US 2009/0025570 A1
(43) Pub. Date: Jan. 29, 2009

(54) WAFFLE IRON HAVING A CHANGEABLE PLATE INSERT FOR CUSTOMIZATION OF WAFFLES MADE THEREIN

(76) Inventor: Gary R. Larson, Provo, UT (US)

Correspondence Address: ANGUS C. FOX, III, 4093 N. IMPERIAL WAY, PROVO, UT, 84604-5386, US

(21) Appl. No.: 12/181,294

(22) Filed: Jul. 28, 2008

Related U.S. Application Data
(60) Provisional application No. 60/952,147, filed on Jul. 26, 2007.

(51) Int. Cl. A47J 37/06

(52) U.S. Cl. 99/376

(57) ABSTRACT

A waffle iron includes upper and lower heatable textured plates which can be separated for dispensing batter thereon and for unloading cooked waffles, a recess in at least one of the heatable textured plates for receiving one of a plurality of inserts which customize waffles cooked therein. Each of the plurality of inserts has a topographically formed name, character or figure thereon, either in relief or by engraving. Each heatable plate which receives an interchangeable insert has a recess into which the insert fits. The recess may be equipped with indexing apertures or indentations. Each insert is equipped with a threaded shaft which passes through apertures in the heatable plate and associated waffle iron body portion. A nut can be secured to the threaded shaft, thereby securing the insert within the recess on the heatable plate.

### PRIORITY DATA

This application has a claim of priority based on the filing of provisional patent application No. 60/952,147 of the same title and by the same inventor on Jul. 26, 2007.

### FIELD OF THE INVENTION

This invention relates, generally, to waffle irons and, more particularly, to a waffle iron having a changeable plate insert for customization of waffles made in the waffle iron.

### BACKGROUND OF THE INVENTION

Waffle irons have been produced for considerably more than a century. Typically, a waffle iron consists of upper and lower heatable patterned plates. The upper plate can be raised in order to dispense pancake batter on the lower, upward-facing plate. The upper plate is then positioned atop the lower plate and the batter is cooked to make a semi-rigid waffle. The cooked waffle is removed by raising the upper plate.

Traditional waffle irons are designed to cook either circular or rectangular waffles. Each heatable plate has a repeating pattern of raised projections, which are responsible for producing the crisp structure of a cooked waffle. Other decorative patterns have also been used on waffle plates. Des. Pat. No. 345,487 and Des. Pat. No. 151,077 are representative of decorative plates that may be used in waffle irons designed for the use of circular heated plates.

### SUMMARY OF THE INVENTION

The present invention provides a waffle iron having a changeable plate insert for customization of waffles made therein. Although the waffle iron is shown and described in the context of plate interchangeable inserts formed in relief or thereon the names of baseball and football teams, the invention can be applied to any decorative element on a replaceable insert. For example, a waffle iron intended for use at a car show might include a plurality of interchangeable inserts, each of which is inscribed with an automotive nameplate. Likewise, a waffle iron intended for use at a children's party might include a plurality of interchangeable inserts, each of which has a cartoon character formed in relief thereon. Although relief is the preferred topographic means of representation, characters and figures may also be formed by engraving. For one embodiment of the invention, each insert is sized to fit within a recess in the upper plate. The recess is equipped with indexing apertures or indentations, and each insert is equipped with pegs which engages the indexing apertures or indentations in order to provide a correct angular orientation of the insert. Each insert has a threaded stud which passes through apertures in the upper plate and the upper body of the waffle iron and is secured against the upper body with a nut. The nut may be covered with a knob made of a material having low thermal conductivity. Additionally or alternatively, the knob may incorporate a plurality of apertures which further reduce thermal conductivity to the outer perimeter.

### BRIEF DESCRIPTION OF THE DRAWINGS

FIG. 1 is an isometric view of a first embodiment waffle iron having a first circular changeable plate insert for customization of waffles made therein;

FIG. 2 is an isometric view of a first embodiment waffle iron having a second circular changeable plate insert for customization of waffles made therein;

FIG. 3 is an isometric view of a first embodiment waffle iron having no circular changeable plate insert installed;

FIG. 4 is an enlarged top plan view of the first circular changeable plate insert;

FIG. 5 is an enlarged top plan view of the second circular changeable plate insert;

FIG. 6 is an enlarged bottom plan view of either the first or second circular changeable plate insert;

FIG. 7 is a side elevational view of either the first or second circular changeable plate insert, showing three of the indexing pegs, the threaded securing post, and a retaining nut;

FIG. 8 is a side elevational view of either the first or second circular changeable plate insert, rotated to show only two of the indexing pegs;

FIG. 9 is a side elevational view of the top body portion of the first embodiment waffle iron, showing either the first or second circular changeable plate insert about to be installed therein;

FIG. 10 is a side elevational view of the top body portion of the first embodiment waffle iron, showing either the first or second circular changeable plate insert installed therein;

FIG. 11 is a side elevational view of the top body portion of the first embodiment waffle iron, showing either the first or second circular changeable plate insert installed therein and secured with a retaining nut;

FIG. 12 an isometric view of a second embodiment waffle iron having a first generally ellipsoid changeable plate insert for customization of waffles made therein; and

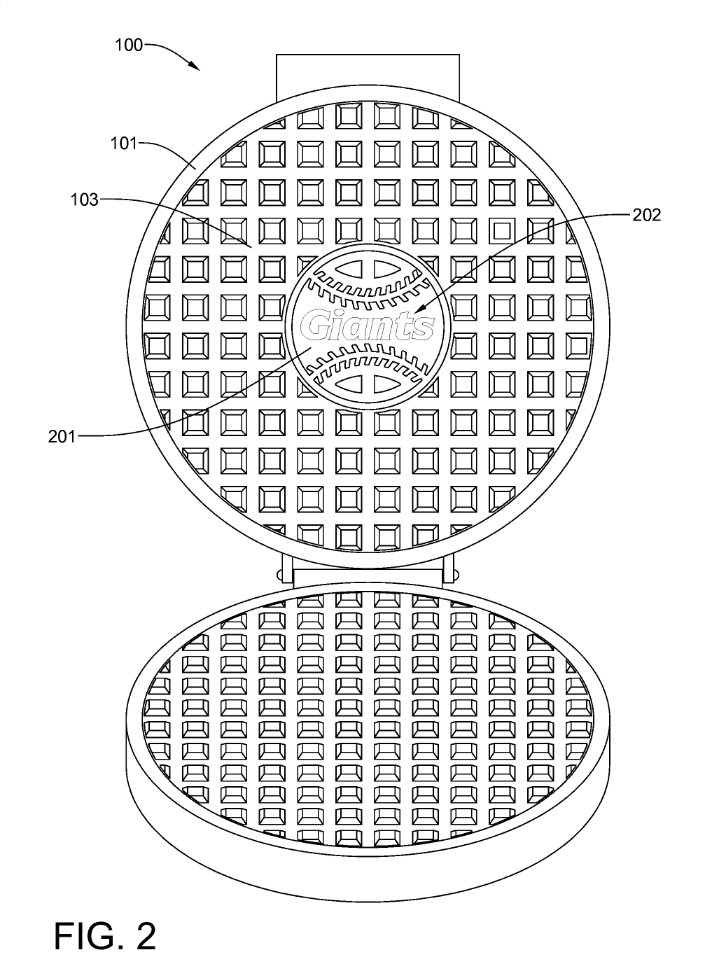

FIG. 2 is an isometric view of a first embodiment waffle iron having a second generally ellipsoid changeable plate insert for customization of waffles made therein.

### PREFERRED EMBODIMENT OF THE INVENTION

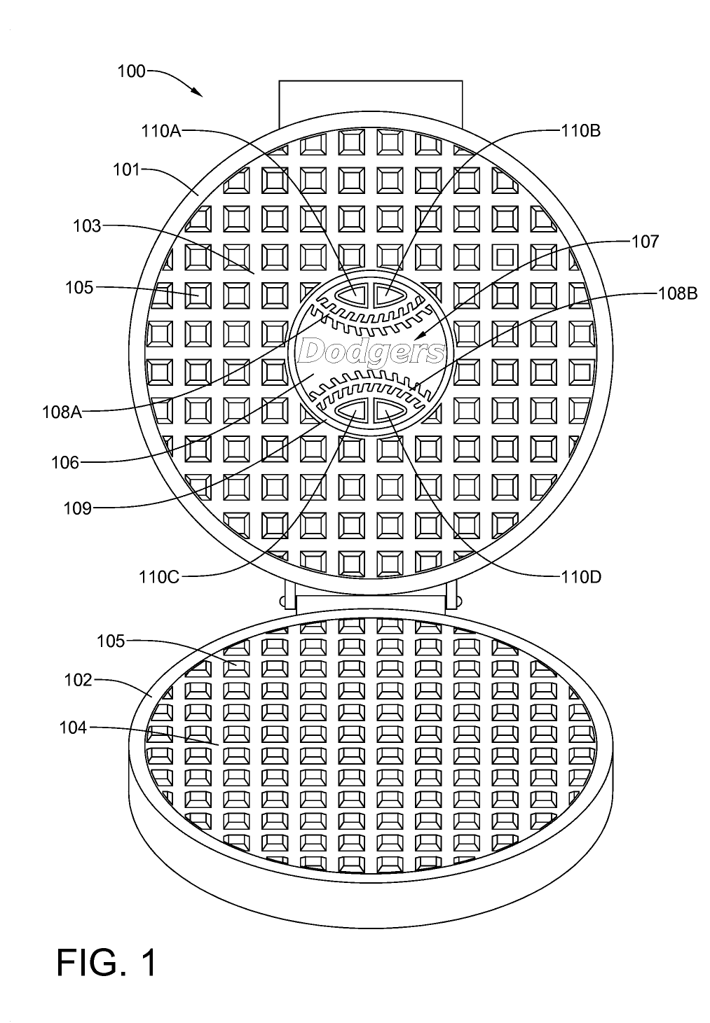

The invention will now be described with reference to the attached drawing FIGS. 1 to 13. It should be understood that the drawing figures are not necessarily drawn to scale and are meant to be merely illustrative of the invention.

Referring now to FIG. 1, a first embodiment waffle iron 100 is shown which is designed to make generally circular waffles. The waffle iron 100 has an upper body portion 101 hingeably coupled to a lower body portion 102. The upper body portion 101 has an upper heatable textured plate 103, while the lower body portion 102 has a lower heatable textured plate 104. Each of the heatable textured plates has an array of generally pyramidally-shaped projections 105. The upper heatable textured plate 103 is equipped with a first central interchangeable insert 106 that has been decorated to resemble a baseball. The first insert 106 bears the name “Dodgers” 107. The name Dodgers 107 the baseball “stitching” 108A and 108B, the outline 109 of the baseball, and generally triangular blocks 110A, 110B, 110C and 110D are formed in relief. Within the upper and lower body portions 101 and 102, respectively, electrical resistance wiring provides a source of heat which is transferred to the textured plates 103 and 104. The waffle iron 100 also includes an electrical connection cord and controls, which are not shown. The upper body portion 101 is equipped with a handle 111.

Referring now to FIG. 2, the first insert 106 bearing the name “Dodgers” has been removed from the upper heatable plate 103 of the first embodiment waffle iron 100 and replaced with a second interchangeable insert 201 bearing the name “Giants” 202.

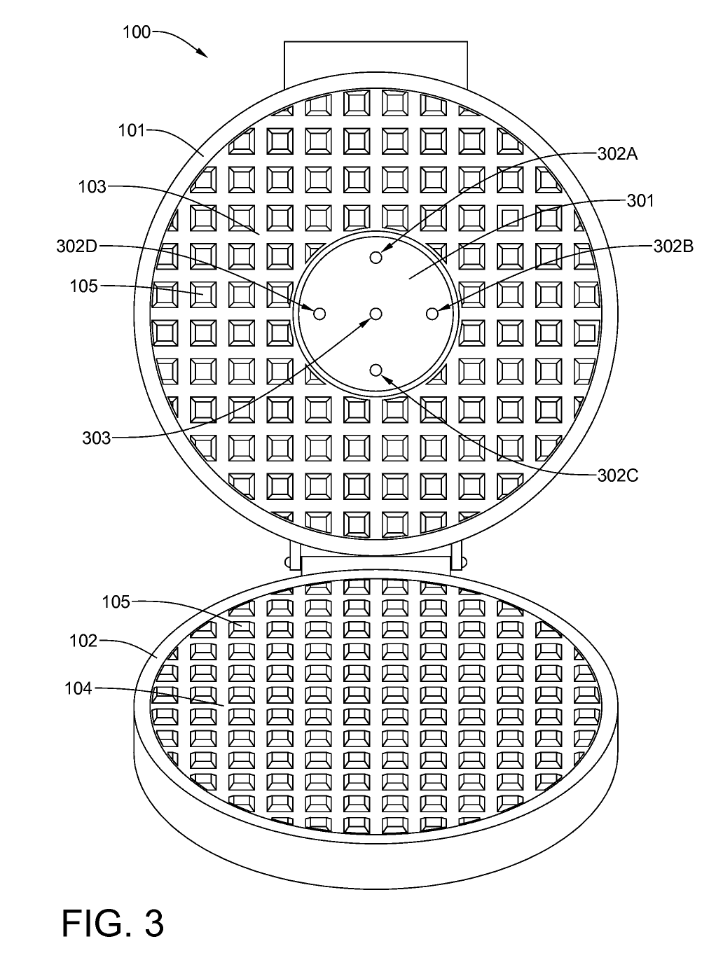

Referring now to FIG. 3, the first embodiment waffle iron 100 is shown without any interchangeable insert installed on the upper heatable plate 103. It will be noted that a circular recess 301 is formed in the upper heatable plate 103. The recess 301 is equipped with four indexing apertures 302A, 302B, 302C and 302D. In the center of the recess 301, a securing aperture 303 extends through the upper heatable plate 103 and all the way through the upper body portion 101.

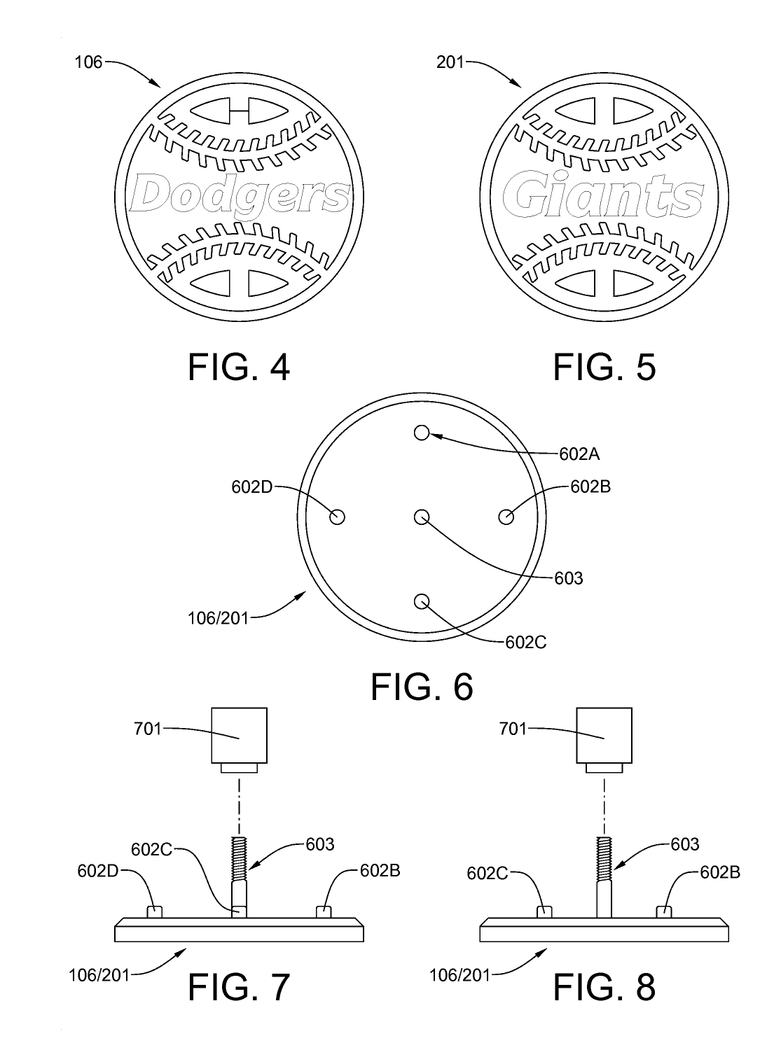

Referring now to FIG. 4, the top surface of the first interchangeable insert 106 bearing the name “Dodgers” is shown in an enlarged view.

Referring now to FIG. 5, the top surface of the second interchangeable insert 201 bearing the name “Giants” is shown in an enlarged view.

Referring now to FIG. 6, the bottom of either the first or second interchangeable insert 106 and 201, respectively, is shown. Either insert has a beveled edge 601, four indexing pegs 602A, 602B, 602C and 602D, as well as a central threaded shaft 603.

Referring now to FIG. 7, either the first or second interchangeable insert 106 or 201 is shown in a side view. In this view, three of the four side indexing pegs 602A, 602B and 602C are visible, as is the central threaded shaft 603. A retaining nut 701, shown above the insert 106, has its threaded aperture (not show) aligned with the threaded shaft 603.

Referring now to FIG. 8, either the first or second interchangeable insert 106 or 201 has been rotated about the axis of the central threaded shaft 603 so that only two indexing pegs 602A and 602B are visible.

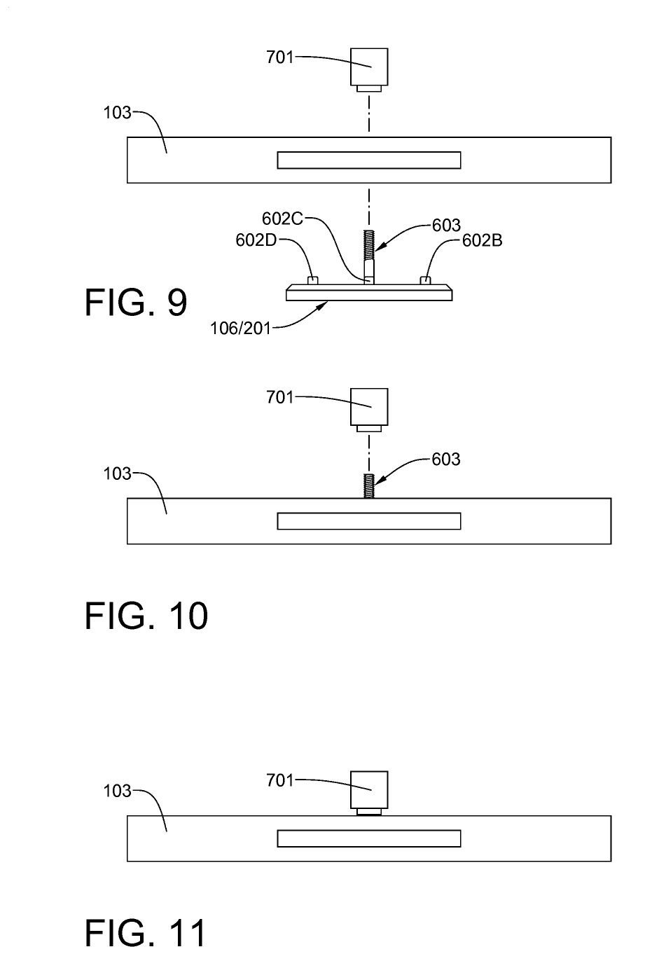

Referring now to FIG. 9, one of the circular interchangeable inserts 106 or 201 is shown positioned for installation in the circular recess 301 of the upper heatable plate 103.

Referring now to FIG. 10, the circular interchangeable insert 106 or 201 has been installed within the circular recess 301 (not shown in this view).

Referring now to FIG. 11, the retaining nut 701 has engaged the threads of the threaded shaft 601, thereby securing the insert 106 or 201 to the upper heatable plate 103.

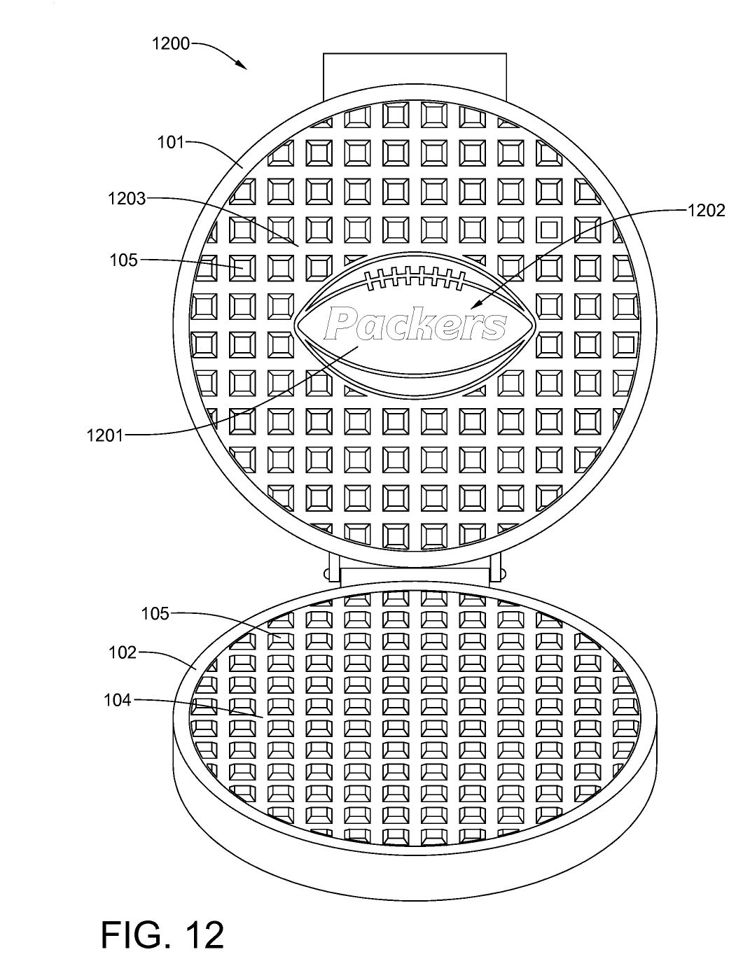

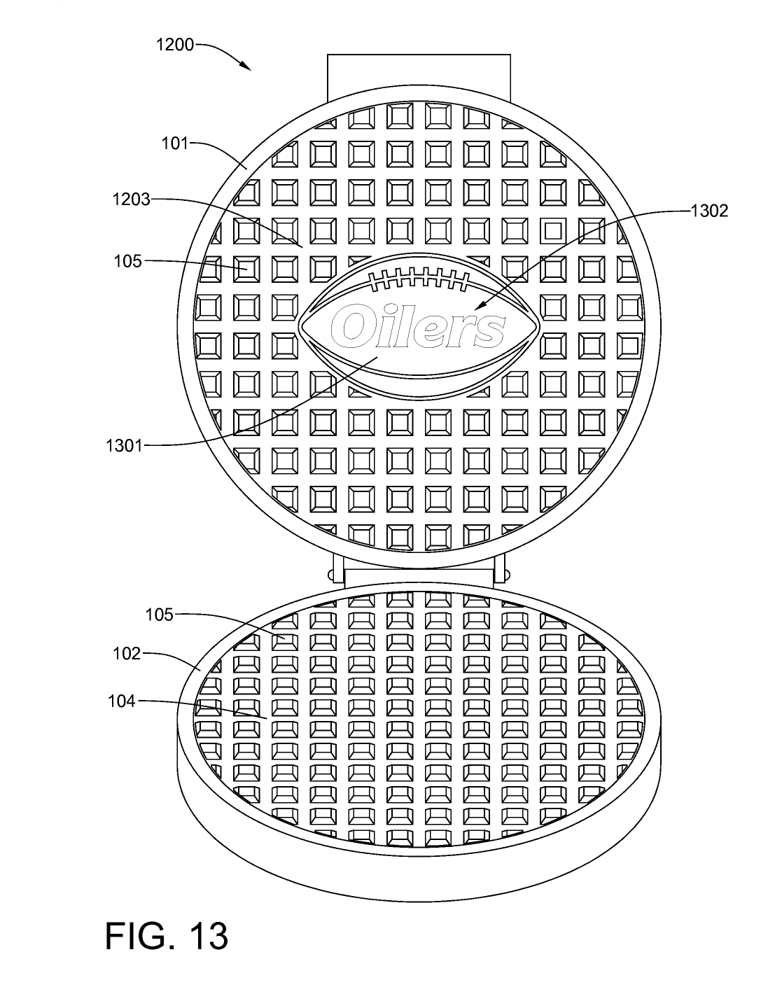

Referring now to FIG. 12, a second embodiment waffle iron 1200 having a first generally ellipsoid interchangeable insert 1201 bearing the name “Packers” 1202 for customization of waffles made therein is shown. The upper heatable plate 1203 of the second embodiment waffle iron 1200 has a generally ellipsoid recess beneath the insert 1201. The generally ellipsoid interchangeable insert 1201 is attached to the upper heatable plate 1203 in the manner employed for the first embodiment waffle iron 100.

Referring now to FIG. 13, Referring now to FIG. 2, the first generally ellipsoid interchangeable insert 1201 has been removed from the upper heatable plate 1203 of the second embodiment waffle iron 1200 and replaced with a second generally ellipsoid interchangeable insert 1301 bearing the name “Oilers” 1302.

Although only several embodiments of the waffle iron having a changeable plate insert for customization of waffles made therein have been heretofore disclosed and described, it will be obvious to those having ordinary skill in the art that changes and modifications may be made thereto without departing from the scope and the spirit of the invention as hereinafter claimed.

What is claimed is:

1. A waffle iron comprising:
a lower body portion;
an upper body portion hingeably coupled to said lower body portion;
lower and upper heatable textured plates respectively secured to said lower body portion and said upper body portion, said lower and upper heatable textured plates being separating from one another for dispensing batter thereon and for unloading of cooked waffles when the lower and upper body portions are open, and said lower and upper heatable textured plates being brought together in a parallel adjacent relationship for cooking the dispensed batter therebetween when the lower and upper body portions are closed;
a recess in at least one of the heatable textured plates;
a plurality of inserts, each of which has a unique topographical design, and any of said inserts being selectable and temporarily installable within said recess in order to customize waffles cooked between the lower and upper heatable textured plates.

2. The waffle iron of claim 1, wherein each of said heatable textured plates incorporates an array of generally pyramidally-shaped projections.

3. The waffle iron of claim 1, wherein each insert comprises securing means which enables a user of the waffle iron to secure that insert within the recess in a non-permanent manner.

4. The waffle iron of claim 3, wherein said securing means comprises at least one threaded fastener which passes through axially-aligned apertures in both the heatable textured plate containing the recess and the body portion to which that heatable textured plate is secured, and which secures the insert to the body portion.

5. The waffle iron of claim 4, wherein said at least one threaded fastener incorporates a knob having low thermal conductivity which it enables it to be loosened with the fingers even when the heatable textured plate is hot.

6. The waffle iron of claim 1 wherein the recess and each insert incorporate indexing means which ensure proper angular orientation of the insert.

7. The waffle iron of claim 1, wherein said indexing means comprise mating pins and recess.

8. The waffle iron of claim 1, wherein each insert is provided with a sports team identifying logo.

9. The waffle iron of claim 1, wherein each insert is provided with the identifying logo of a commercial product.

10. The waffle iron of claim 1, wherein each insert is provided with an identifiable cartoon character.

11. A waffle iron comprising:
lower and upper heatable textured plates which are both separable from one another for dispensing batter thereon and for unloading of cooked waffles and positionable in a parallel adjacent relationship for cooking the dispensed batter therebetween;
a recess in at least one of the heatable textured plates;
a plurality of inserts, each of which has a unique topographical design, and any of said inserts being selectable and temporarily installable within said recess in order to customize waffles cooked between the lower and upper heatable textured plates.

12. The waffle iron of claim 11, wherein each of said heatable textured plates incorporates an array of generally pyramidally-shaped projections.

13. The waffle iron of claim 11, wherein each insert comprises securing means which enables a user of the waffle iron to secure that insert within the recess in a non-permanent manner.

14. The waffle iron of claim 13, wherein each insert is securable within the recess by means of at least one threaded fastener.

15. The waffle iron of claim 44, wherein said at least one threaded fastener incorporates a knob having low thermal conductivity which it enables it to be loosened with the fingers even when the heatable textured plate is hot.

16. The waffle iron of claim 11 wherein the recess and each insert incorporate indexing means which ensure proper angular orientation of the insert.

17. The waffle iron of claim 11, wherein said indexing means comprise mating pins and recess.

18. The waffle iron of claim 11, wherein each insert is provided with a sports team identifying logo.

19. The waffle iron of claim 11, wherein each insert is provided with the identifying logo of a commercial product.

20. The waffle iron of claim 11, wherein each insert is provided with an identifiable cartoon character.
